(19) United States
(12) Patent Application Publication
(10) Pub. No.: US 2024/0102825 A1
(43) Pub. Date: Mar. 28, 2024

(54) OWN-VEHICLE POSITION INTEGRATION PROCESSING APPARATUS AND OWN-VEHICLE POSITION INTEGRATION PROCESSING METHOD

(71) Applicant: Mitsubishi Electric Corporation, Tokyo (JP)

(72) Inventors: Koji IIDA, Tokyo (JP); Takuya TANIGUCHI, Tokyo (JP)

(73) Assignee: Mitsubishi Electric Corporation, Tokyo (JP)

(21) Appl. No.: 18/039,528

(22) PCT Filed: Mar. 18, 2021
(86) PCT No.: PCT/JP2021/011141

§ 371 Date: May 31, 2023

(51) Int. Cl. G01C 21/00

(52) U.S. Cl. CPC G01C 21/3844

(57) ABSTRACT

An own-vehicle position integration processing apparatus calculates with a prediction circuitry, based on own-vehicle movement information u(m) obtained from an own-vehicle movement information observation device and an observation time point t_{ego}(m) thereof and on own-vehicle position information z(n) obtained from a plurality of own-vehicle position observation devices and an observation time point t_{obs}(n) thereof, an own-vehicle position prediction value x_{pred}(n) at the observation time point t_{obs}(n), acquires a previous observation time point t_{obs}(n−1) and an own-vehicle position estimation value xₑₛₜ(n−1) thereat from an updating circuitry, sequentially updates using them the own-vehicle position prediction value x_{pred}(n) at the observation time point t_{obs}(n) per item of own-vehicle position information z(n), and calculates an own-vehicle position xₒᵤₜ(n) at a target output time point tₒᵤₜ from an own-vehicle position estimation value xₑₛₜ(n). Thereby, a precise own-vehicle position can be estimated.

### TECHNICAL FIELD

The present application relates to the field of an own-vehicle position integration processing apparatus and an own-vehicle position integration processing method.

### BACKGROUND ART

It is required for an automatic operating device on a vehicle to obtain its own-vehicle position with high precision. As an own-vehicle position calculation method, there is a satellite positioning method using a GNSS (Global Navigation Satellite System), an inertial navigation method using an internal sensor including a gyro, or a map matching method which detects the feature information around the own vehicle using an external sensor (for example, a perimeter monitoring camera, a Lidar (Light detection and ranging), or a millimeter-wave radar) and matches the result of the detection with the feature information stored in a known map. Furthermore, there is also a method of robustly estimating an own-vehicle position by combining these techniques.

As the method of estimating an own-vehicle position, for example, in an own-vehicle position estimating device described in PTL 1, a second own-vehicle position with which to estimate an own-vehicle position by matching map information with an image shot by a camera is estimated based on a first own-vehicle position obtained from an in-vehicle positioning section, thus facilitating an improvement in the accuracy of estimation of a third own-vehicle position on a map equipped on the own vehicle by using the information on a vehicle speed and the like.

### CITATION LIST

### Patent Literature

PTL 1: JP2018-21777A

### SUMMARY OF INVENTION

### Technical Problem

With the own-vehicle position estimating method including that of PTL 1, however, there is sometimes a decrease in own-vehicle position accuracy when integrating a plurality of own-vehicle position observation results. As the factors therefor, the undermentioned two points can be considered.
(a) Asynchronous operation between a plurality of observation devices
(b) Asynchronous operation between the observation devices and an integration processing apparatus

As for (a), generally, in own-vehicle position estimation devices, own-vehicle position information updating cycles in their different techniques differ from one another. Furthermore, when the individual devices operate independently of each other, own-vehicle observation time points also differ from one another. When integrating own-vehicle positions observed at such a plurality of different time points, there is a problem in that the accuracy of estimation of the own-vehicle positions after the integration decreases unless the difference in observation time points between the observation devices is taken into consideration.

As for (b), operation cycles and operation timings are not in synchronism between the observation devices and the integration processing apparatus, either. That is, the observation time points (time points at which to observe with the observation devices) do not conform to an output time point (time point at which to intend to estimate with the integration processing apparatus). Because of this, there is a problem in that even when these differences in time points are not taken into consideration, there occurs a factor to decrease the accuracy of estimation of an own-vehicle position at the output time point.

The present application has been made to solve the above problems, and an object of the present application is to provide an own-vehicle position integration processing apparatus and an own-vehicle position integration processing method which can carry out own-vehicle position estimation with high precision with respect to a problem of asynchronous operation between a plurality of observation devices which observe an own-vehicle position and to a problem of asynchronous operation between the observation devices and the integration processing apparatus.

### Solution to Problem

An own-vehicle position integration processing apparatus disclosed in the present application includes a prediction section which, by using own-vehicle movement information and an observation time point, which are acquired from an own-vehicle movement information observation device, a present and a previous observation time point of own-vehicle position information acquired from own-vehicle position observation devices, and an estimation value of a previous own-vehicle position at the previous observation time point, calculates a prediction value of a present own-vehicle position at the present observation time point; an updating section which calculates and updates an estimation value of the own-vehicle position at the present observation time point by using the prediction value acquired from the prediction section, the present observation time point, and the present own-vehicle position; and an output section which calculates and outputs an output value in conformity with a predetermined output time point by using the estimation value, the own-vehicle movement information, and the observation time points.

Also, an own-vehicle position integration processing method disclosed in the present application includes a step which, by using own-vehicle movement information and an observation time point, which are acquired from an own-vehicle movement information observation device, a present and a previous observation time point of own-vehicle position information acquired from own-vehicle position observation devices, and an estimation value of a previous own-vehicle position at the previous observation time point, calculates a prediction value of a present own-vehicle position at the present observation time point; a step which calculates and updates an estimation value of the own-vehicle position at the present observation time point by using the prediction value, the present observation time point, and the present own-vehicle position; and a step which calculates and outputs an output value in conformity with a predetermined output time point by using the estimation value, the own-vehicle movement information, and the observation time points.

### Advantageous Effects of Invention

According to the own-vehicle position integration processing apparatus and own-vehicle position integration processing method of the present application, there is an advantageous effect in that when estimating own-vehicle positions by integrating items of information on own-vehicle positions observed by a plurality of methods by considering an observation time point and a predetermined output time point, respectively, the items of own-vehicle position information are integratively processed, thus enabling precise estimation of the own-vehicle position.

### BRIEF DESCRIPTION OF DRAWINGS

FIG. 1 is a block diagram showing the overall outline configuration of an own-vehicle position integration processing system including an own-vehicle position integration processing apparatus according to a first embodiment of the present application.

FIG. 2 is a block diagram showing an example of the own-vehicle position integration processing apparatus according to the first embodiment.

FIG. 3 is a diagram describing the relationship between observation values and output values in own-vehicle positions.

FIG. 4 is a diagram schematically showing the operation of an own-vehicle position integration processing method in the first embodiment.

FIG. 5 is a diagram showing the relationship between the observation values, prediction values, estimation values, and output values in the own-vehicle positions in FIG. 4.

FIG. 6 is a diagram showing the flow chart of external information acquisition processing in the first embodiment.

FIG. 7 is a diagram showing the time chart of the operation of observation devices, and of the operation of the own-vehicle position integration processing apparatus, in the first embodiment.

FIG. 8 is a diagram showing the flow chart of own-vehicle position integration processing in the first embodiment.

FIG. 9 is a diagram showing the time chart of amendment time points and observation time points of own-vehicle movement information in the first embodiment.

### DESCRIPTION OF EMBODIMENTS

### First Embodiment

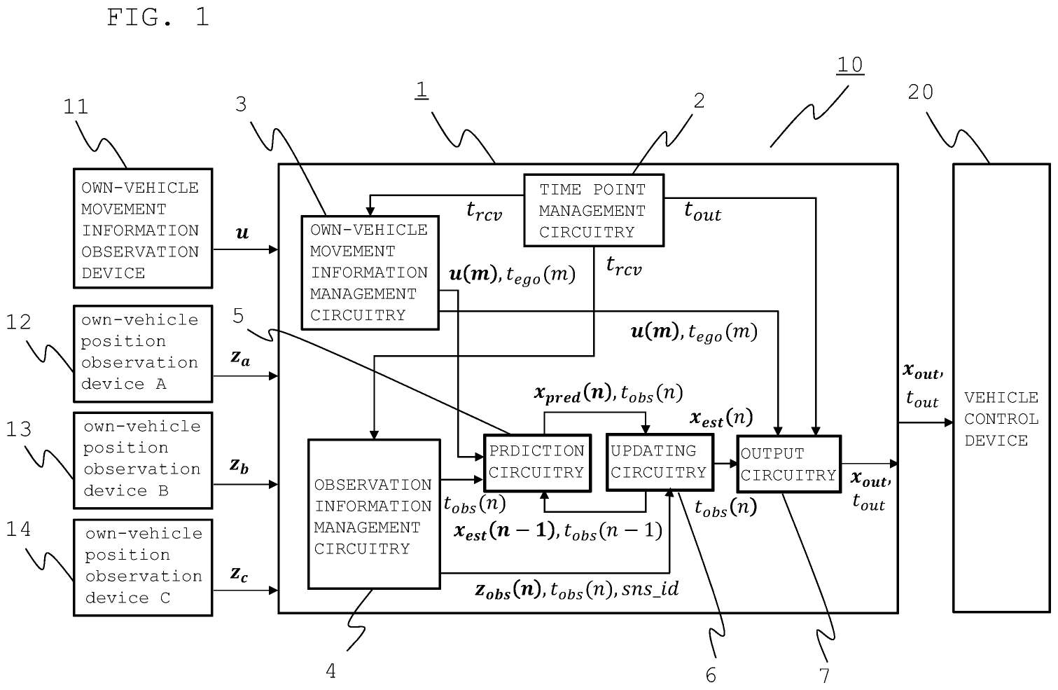

FIG. 1 is a block diagram showing the overall outline configuration of an own-vehicle position integration processing system including an own-vehicle position integration processing apparatus according to a first embodiment.

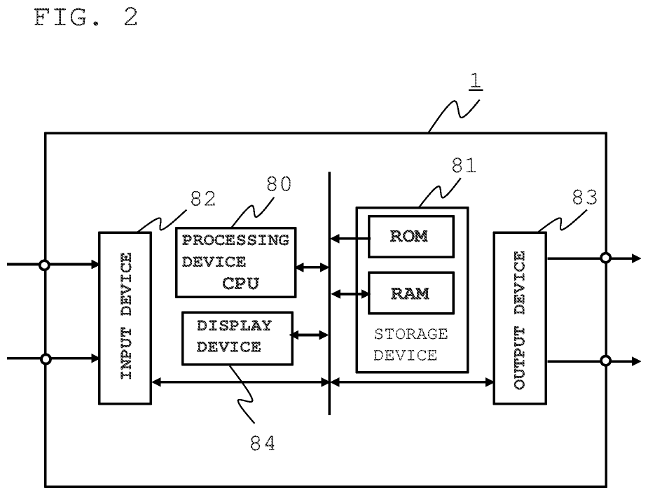

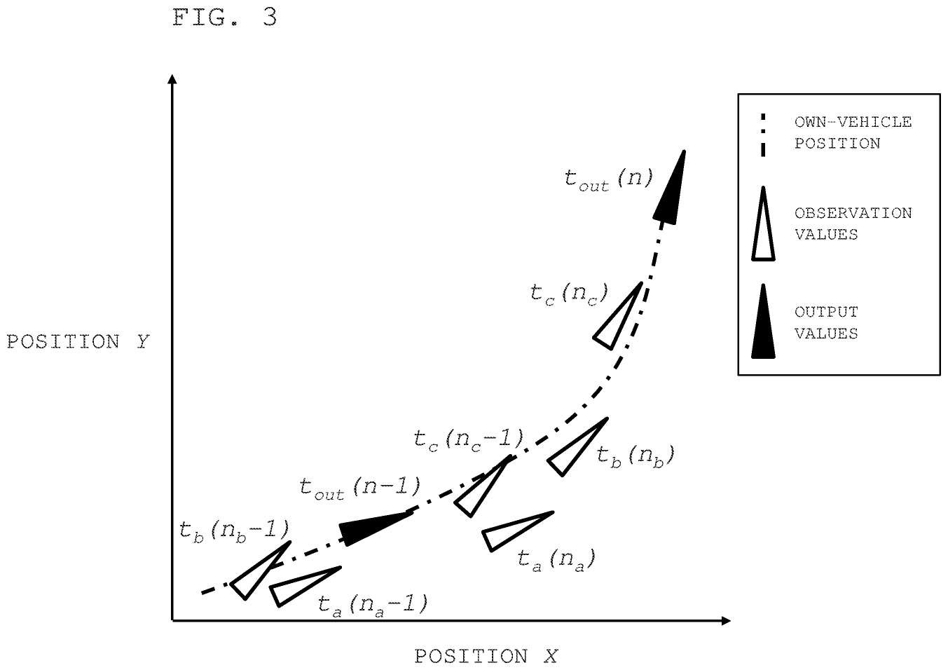

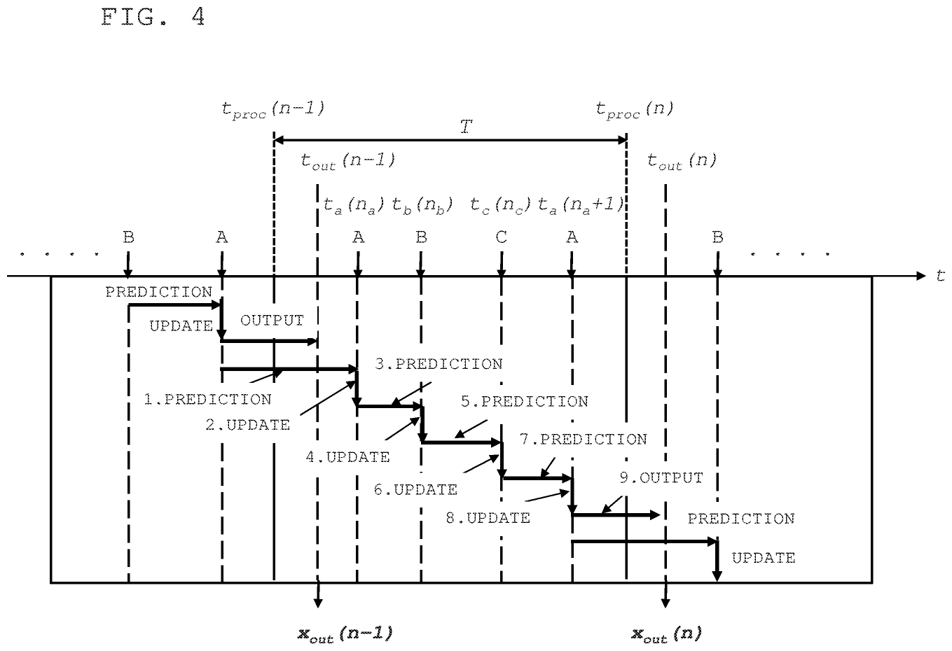

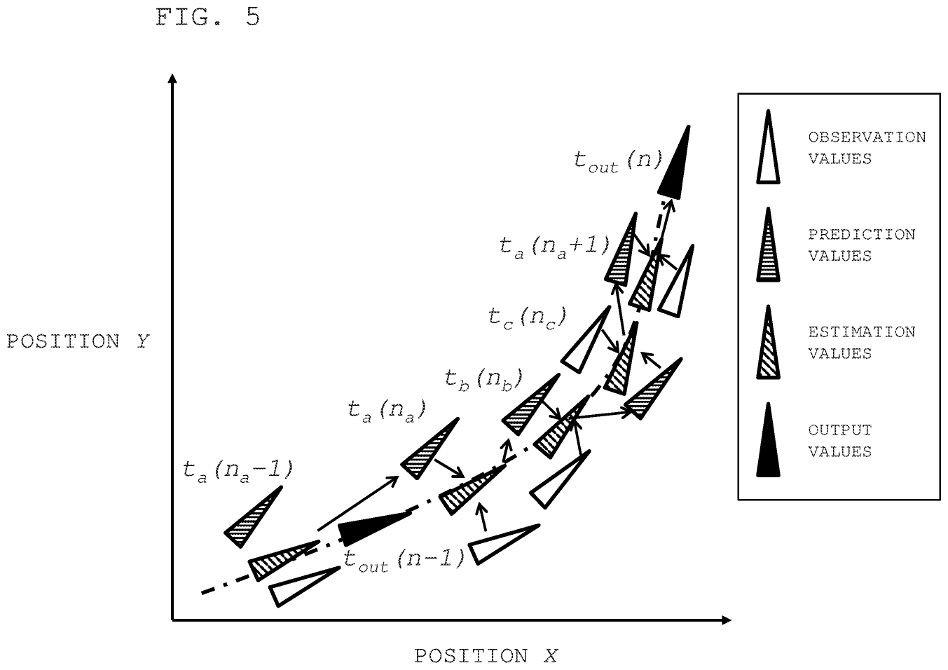

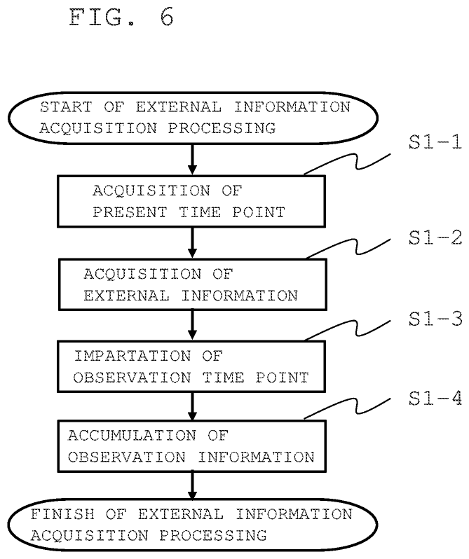

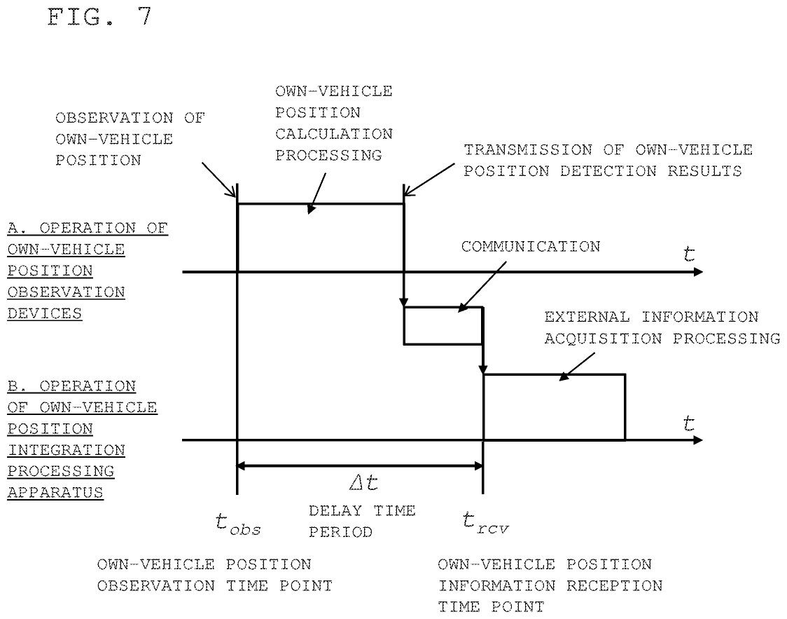

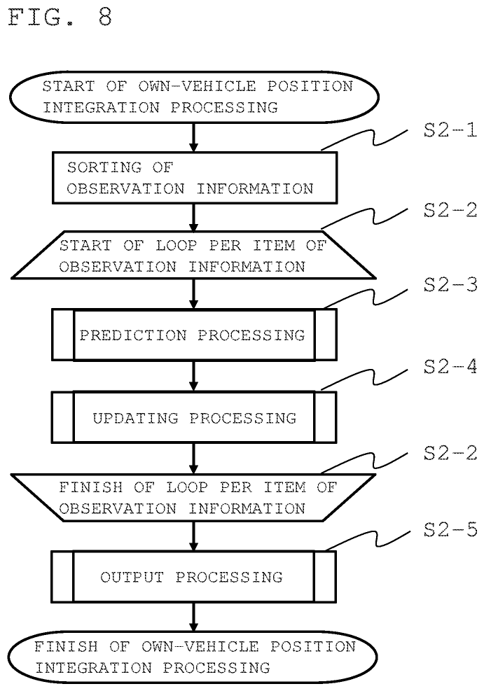

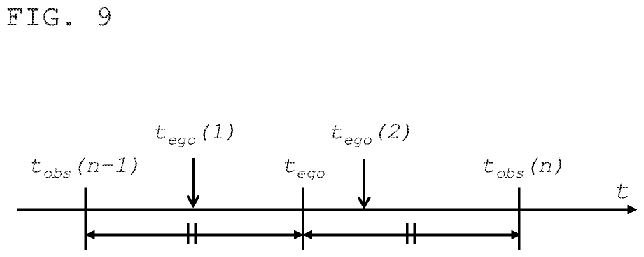

FIG. 2 is a block diagram showing an example of the own-vehicle position integration processing apparatus according to the first embodiment. FIG. 3 is a diagram describing the relationship between own-vehicle position observation and output values. FIG. 4 is a diagram schematically showing the operation of an own-vehicle position integration processing method in the first embodiment. FIG. 5 is a diagram showing the relationship between the own-vehicle position observation, prediction, estimation, and output values in FIG. 4. FIG. 6 is a diagram showing the flow chart of external information acquisition processing in the first embodiment. FIG. 7 is a diagram showing the time chart of the operation of observation devices, and of the operation of the own-vehicle position integration processing apparatus, in the first embodiment. FIG. 8 is a diagram showing the flow chart of own-vehicle position integration processing in the first embodiment. Also, FIG. 9 is a diagram showing the time chart of own-vehicle movement information amendment and observation time points in the first embodiment.

First, a description will be given, using FIG. 1, of the configuration of an own-vehicle position integration processing system 10 according to the first embodiment.

The own-vehicle position integration processing system 10 is configured of an own-vehicle position integration processing apparatus 1, an own-vehicle movement information observation device 11 which provides own-vehicle movement information to the own-vehicle position integration processing apparatus 1, own-vehicle position observation devices 12, 13, 14 (here described as own-vehicle position observation devices A, B, C) which provide own-vehicle position information, and a vehicle control device 20 which provides the own-vehicle position information estimated in the own-vehicle position integration processing apparatus 1.

The own-vehicle position integration processing apparatus 1 is configured of a time point management section 2 which manages an operation time point tᵣₑᵥ of the own-vehicle position integration processing apparatus 1, an own-vehicle movement information management section 3 which acquires own-vehicle movement information u (speed, yaw rate, acceleration, etc.) from the external own-vehicle movement information observation device 11 and sets an observation time point t_{ego} (m) of movement information u(m) acquired, an observation information management section 4 which acquires items of own-vehicle position information zₐ, z_{b}, zₑ from the external own-vehicle position observation device 12, own-vehicle position observation device 13, and own-vehicle position observation device 14 which carry out own-vehicle position observation (calculation) and sets an observation time point t_{obs} (n) of own-vehicle position information z (n) acquired, a prediction section 5 which acquires the own-vehicle movement information u(m) acquired from the own-vehicle movement information management section 3, the observation time point t_{ego}(m) thereof, the own-vehicle position observation time point t_{obs}(n), and a previous processing time point t_{obs}(n−1) and an own-vehicle position estimation value xₑₓₜ (n−1) which are from an updating section 6 to be described later, and using them, calculates an own-vehicle position prediction value x_{pred}(n) at the observation time point t_{obs}(n), the updating section 6 which acquires the prediction value x_{pred}((n), which is calculated by the prediction section 5, and an item of observation position information z_{obs} (n) and the observation time point t_{obs} (n) which are from the observation information management section 4, and using them, calculates the estimation value xₑₛₜ (n−1) at the observation time point t_{obs} (n−1), and an output section 7 which acquires a predetermined output time point tₒᵤₜ of the own-vehicle position integration processing apparatus 1 from the time point management section 2, an estimation value xₑₛₜ(n) and the observation time point t_{obs}(n) from the updating section 6, and the movement information u(m) and the observation time point t_{ego}(m) thereof from the own-vehicle movement information management section 3, and using them, calculates an own-vehicle position xₒᵤₜ at the output time point tₒᵤₜ, and outputs it to, for example, the external vehicle control device 20.

In the present embodiment, the case of acquiring the three items of own-vehicle position information zₐ, z_{b}, z_{c} is described as an example, but there only have to be one or more items of own-vehicle position information, and the configuration in the own-vehicle position integration processing apparatus 1 remains unchanged.

As shown in FIG. 2, the individual functional sections 2 to 7 included by the own-vehicle position integration processing apparatus 1 can be realized by a processing device 80, a storage device 81, an input device 82, an output device 83, and a display device 84.

Here, the processing device 80 may be dedicated hardware or may also be a CPU which executes a program stored in the storage device 81 (Central Processing Unit, also called a central processor, a microprocessor, a microcomputer, a processor, or a DSP).

When the processing device 80 is dedicated hardware, for example, a single circuit, a multiple circuit, a programmed processor, a parallel programmed processor, an ASIC, an FPGA, or a combination thereof corresponds to the processing device 80. The respective functions of the time point management section 2, the own-vehicle movement information management section 3, the observation information management section 4, the prediction section 5, and the updating section 6 may each be realized by the processing device 80, or the functions of the individual sections may also be realized together by the processing device 80.

The output section 7 can be realized by the output device 83. Also, the input device 82 is realized as one portion of the functions of the own-vehicle movement information management section 3 and observation information management section 4, but may be provided separately.

When the processing device 80 is a CPU, the respective functions of the time point management section 2, the own-vehicle movement information management section 3, the observation information management section 4, the prediction section 5, the updating section 6, and the output section 7 are realized by software, firmware, or a combination of software and firmware. Software and firmware are described as processing programs and stored in the storage device 81. The processing device 80 retrieves and executes the processing programs stored in the storage device 81 and thereby realizes the functions of the individual sections. That is, the own-vehicle position integration processing apparatus 1 includes the storage device 81 for storing the processing programs wherein a processing step which loads the data u, zₐ, z_{b}, z_{c} from the own-vehicle movement information observation device 11 and the own-vehicle position observation devices 12, 13, 14, a processing step which sets a movement information observation time point according to the acquired data, a processing step which sets an own-vehicle position information observation time point, a processing step which calculates a prediction value at the observation time point, a processing step which calculates an estimation value at the observation time point, and a processing step which calculates an own-vehicle position and outputs it to the external vehicle control device eventually come to be executed when the processing programs are executed by the processing device 80.

Also, these processing programs can also be said to be ones which cause a computer to execute the procedures or methods of the time point management section 2, the own-vehicle movement information management section 3, the observation information management section 4, the prediction section 5, the updating section 6, and the output section 7. Here, for example, a non-volatile or volatile semiconductor memory, including a RAM, a ROM, a flash memory, an EPROM, or an EEPROM, a magnetic disk, a flexible disk, an optical disk, a compact disk, a mini disk, or a DVD corresponds to the storage device 81.

As for the functions of the time point management section 2, the own-vehicle movement information management section 3, the observation information management section 4, the prediction section 5, and the updating section 6, some portions may be realized by dedicated hardware, while some portions may be realized by software or firmware. For example, the functions of the time point management section 2, the own-vehicle movement information management section 3, and the observation information management section 4 can be realized by the processing device 80 acting as dedicated hardware, and the functions of the prediction section 5 and the updating section 6 can be realized by the processing device 80 retrieving and executing the programs stored in the storage device 81.

In this way, the processing device 80 can realize the above-described individual functions with hardware, software, firmware, or a combination thereof.

The storage device 81, in addition to storing the programs which execute the above-described processing steps, stores the movement information, the position information, which are acquired respectively from the own-vehicle movement information observation device 11 and the own-vehicle position observation devices 12 to 14, and the calculated prediction value and estimation value.

Also, as the input device 82, here, the own-vehicle movement information management section 3 and the observation information management section 4 realize the function thereof, but these management sections acquire data, which are outputted from the own-vehicle movement information observation device 11 and own-vehicle position observation devices 12 to 14, periodically at predetermined time points. The output device 83 corresponds to the output section 7 and outputs processing results to the vehicle control device which is an external device. The display device 84 appropriately displays the situations executed in the processing device 80.

Next, a description will be given of the point and outline of the operation of the present application. As described in the technical problem, one or more of the own-vehicle position observation devices 12, 13, 14 (here described as the own-vehicle position observation devices A, B, C) and the own-vehicle position integration processing apparatus (an apparatus which integratively processes a plurality of observation results regarding own-vehicle positions) 1 operate asynchronously. In this case, as shown in FIG. 3, observation time points (tₐ(nₐ), t_{b}(n_{b}), t_{c}(n_{c}) in the drawing) of the own-vehicle position observation devices 12, 13, 14 do not necessarily conform to a predetermined output time point (tₒᵤₜ (n)) which the own-vehicle position integration processing apparatus 1 aims at, so that an observation value does not conform to an estimation value at the predetermined output time point. Also, the number of own-vehicle positions to be outputted from a single own-vehicle position observation device is not limited to one for a period between the output time points (tₒᵤₜ (n−1)) and (tₒᵤₜ (n)), and there is also the case in which a plurality of observation values are inputted or the case in which no observation value is inputted. In order to deal with this kind of situation, an own-vehicle position integration processing method which takes into consideration the difference between an observation time point and an output time point is required. FIG. 1 shows the configuration of the own-vehicle position integration processing apparatus 1 when realizing the integration processing method, and FIG. 4 schematically shows the operation of the integration processing method.

As shown in FIG. 1, the observation results zₐ, z_{b}, zₑ of the own-vehicle position information which, differing in character from the own-vehicle movement information u, is observed by the plurality of own-vehicle position observation devices 12, 13, 14 are inputted into the own-vehicle position integration processing apparatus 1. The own-vehicle position integration processing apparatus 1 is configured of the time point management section 2, the own-vehicle movement information management section 3, the observation information management section 4, the prediction section 5, the updating section 6, and the output section 7. At this time, as shown in FIG. 4, the own-vehicle position integration processing is executed in a certain cycle T (processing time points t_{proc} (n−1), t_{proc} (n), t_{proc} (n+1), . . . ). On the other hand, the own-vehicle position integration processing apparatus 1 receives the own-vehicle position information observation results zₐ, z_{b}, z_{c} asynchronously from the respective own-vehicle position observation devices 12, 13, 14. The outline of processing in the own-vehicle position integration processing apparatus 1 at this time is such that prediction processing, updating processing, and output processing are sequentially carried out in the order of 1 to 9 in FIG. 4. FIG. 5 is a schematic diagram showing the own-vehicle positions when the prediction processing, the updating processing, and the output processing are carried out sequentially.

Next, a description will be given of a series of processing operations shown in FIG. 4.

(1) Prediction (to which the processes 1, 3, 5, 7 in FIG. 4 correspond) is carried out, from the own-vehicle position estimation value xₑₛₜ(n−1) updated at the previous observation time point t_{obs}(n−1), by using the own-vehicle movement information u(m) in the own-vehicle position obtained by the own-vehicle movement information observation device 11 at the observation time point t_{obs}(n). Own-vehicle position updating (to which the processes 2, 4, 6, 8 in FIG. 4 correspond) is carried out by using the prediction value x_{pred}((n) and an own-vehicle position observation value x_{obs}(n) obtained by the own-vehicle position observation devices 12 to 14. The prediction processing and the updating processing can be carried out using a heretofore known technology such as a Kalman filter.

(2) The above-mentioned prediction processing and updating processing are sequentially executed in chronological order of the observation time points obtained by the own-vehicle movement information observation device 11 and the own-vehicle position observation devices 12 to 14.

(3) At this time, an observation error parameter is appropriately changed for every observation device, thus estimating the own-vehicle position xₑₛₜ((n).

(4) The processing of prediction according to the own-vehicle movement information at the output time point tₒᵤₜ (output processing) is carried out based on the result of the prediction and updating processing at the observation time point t_{obs} (n) closest to the output time point tₒᵤₜ, thereby estimating the own-vehicle position xₒᵤₜ.

In this way, the processing with the observation time point t_{obs}(n) and the output time point tₒᵤₜ taken into consideration is carried out by integrating the own-vehicle position information, thereby enabling an improvement in own-vehicle position estimation accuracy.

Next, a description will be given, using the flow charts shown in FIGS. 6 and 8, of the operation of the own-vehicle position integration processing apparatus 1 of the present embodiment. In FIG. 6 is shown the operation flow when acquiring information (observation information regarding both the own-vehicle movement information u and the own-vehicle position information z) obtained from outside the own-vehicle position integration processing apparatus 1. The acquisition of these items of information is executed when the external information is inputted into the own-vehicle position integration processing apparatus 1. Also, in FIG. 8 is shown the operation flow of the processing of integrating the own-vehicle position information obtained from outside the own-vehicle position integration processing apparatus 1. These processing flows are repeatedly executed at predetermined time intervals. A description will be given below of the details of the contents of external information acquisition processing and own vehicle position integration processing.

First, a description will be given, using the flow chart of FIG. 6, of the procedure of the external information acquisition processing.

<Step S1-1: Present Time Point Acquisition Step>

Upon the start of the external information acquisition processing, first, in this step, the processing of acquiring a present time point tᵣₑᵥ at which to start the external information acquisition processing. Here, a time point at which this processing is retrieved is acquired from the time point management section 2.

<Step S1-2: External Information Acquisition Step>

Next, in this step, the processing of acquiring external information is carried out. Here, an identifier sns_id which identifies the type of the acquired external information (in this example, the own-vehicle position information z(n) of the own-vehicle position observation devices 12, 13, 14 or the own-vehicle movement information u(m) of the own-vehicle movement information observation device 11) is imparted by the observation information management section 4.

<Step S1-3: Observation Time Point Impartation Step>

Furthermore, in this step, the processing of imparting the observation time point t_{obs} is carried out. Here, the time point at which the external information (the own-vehicle movement information or the own-vehicle position observation information) acquired in this step is observed is imparted to the observation information.

As shown in FIG. 7, the observation time point t_{obs} at which the observation is carried out by the observation devices does not necessarily conform to a reception time point tᵣₑᵥ at which the observation information is received by the own-vehicle position integration processing apparatus 1. This is because there exists a delay time period Δt which is obtained by totaling up a time period required to calculate an own-vehicle position in the observation devices or a time period required to transmit to own-vehicle position integration processing apparatus 1 from the observation devices. Therefore, the delay time period Δt is preset for every observation device.

In this step, first, Δt is set depending on the observation devices by using the external information identification result obtained in Step S1-2. Then, the delay time period Δt per observation device is subtracted from the time point tᵣₑᵥ at which the external information is received, thereby amending the observation time point (t_{obs}(n)=tᵣₑᵥ(n)−Δt). The amended time point is imparted to the observation information as the observation time point t_{obs}(n). When each of the own-vehicle position observation devices 12, 13, 14 outputs the observation time point t_{obs}, the value transmitted from the observation device is used as the observation time point t_{obs}(n))=t_{obs}.

<Step S1-4: Observation Information Accumulation Step>

Finally, in this step, the processing of accumulating (storing) the observation information is carried out. Here, the identifier sns_id and the observation time point t_{obs} are imparted per external information type to the observation information which, having been set as above, is obtained from outside, and in the event that they are the own-vehicle movement information, they are accumulated in the own-vehicle movement information management section 3, while in the event that they are the own-vehicle position information, they are accumulated in the observation information management section 4.

This is the end of the external information acquisition processing.

Subsequently, a description will be given, using the flow chart of FIG. 8, of the procedure of the own-vehicle position integration processing. The contents of the processing in each step are as follows. Upon calculating the prediction value in Step S2-3-2 of this processing and calculating the estimation value in the updating processing of Step S2-4-2, the equations in the case of using a Kalman filter as an example will be shown.

<Step S2-1: Observation Information Sorting Processing Step>

Upon the start of the own-vehicle position integration processing, first, in this step, the processing of sorting the observation information is carried out. Here, sorting of a plurality of items of observation information z_{obs} which have been accumulated in the observation information management section 4 by the time when this processing starts is carried out in ascending order on the basis of the observation time point t_{obs} imparted in the external information acquisition processing.

<Step S2-2: Per-Observation-Information Loop Processing Step>

Next, in this step, loop processing per observation information is carried out. Here, the prediction processing in Step S2-3 and the updating processing in Step S2-4 are carried out with respect to the output time point tₒut, subsequent n=1, 2, . . . , and N items of observation information out of the plurality of items of observation information sorted in Step S2-1. Target observation information is sequentially selected, in chronological order of the observation time points t_{obs}, from among the items of old observation information t_{obs}(1)<t_{obs} (2)< . . . <t_{obs}(N)<=tₒᵤₜ sorted in Step S2-1, and the processing is carried out with respect to the selected observation information.

<Step S2-3: Own-Vehicle Position Prediction Processing Step>

Furthermore, in this step, the own-vehicle position prediction processing is carried out. Here, the prediction processing is carried out with the following as input/output information.
Input/Output: t_{obs}(n): Observation time point at which own-vehicle position information z(n) is observed by own-vehicle position observation devices
Input: t_{ego}(m): Observation time points, close to own-vehicle position observation time point t_{obs}(n), at which M items of own-vehicle movement information are observed
Input: u(m): M items of own-vehicle movement information corresponding to t_{ego}(m)
Input t_{obs}(n−1): Own-vehicle position information observation time point in previous updating processing
Input xₑₛₜ(n−1): Own-vehicle position estimation value in previous updating processing
Output: x_{pred}(n): Own-vehicle position prediction value at time point t_{obs}(n) calculated in prediction processing

<Step S2-3-1: Own-Vehicle Movement Information Amendment Step>

In this step, amendment of the own-vehicle movement information is carried out. Here, the own-vehicle movement information u(m) which is input information is amended to the own-vehicle movement information u(n) at the time point t_{ego}. The amended u(n) is used to calculate the own-vehicle prediction value at the time point t_{obs}(n).

As shown in FIG. 9, as for the own-vehicle movement information, the own-vehicle position information at a desired time point t_{ego} (for example, t_{obs} (n) or the time point at the midpoint between t_{obs} (n−1) and t_{obs} (n)) cannot be acquired, either.

In FIG. 9, t_{ego} designates the own-vehicle movement information time point after amendment, t_{ego}(1) the own-vehicle movement information observation time point closest to t_{ego}, t_{ego} (2) the own-vehicle movement information observation time point second closest to t_{ego}, t_{obs}(n−1) the own-vehicle position information observation time point in the previous updating processing, and t_{obs} (n) the observation time point at which the own-vehicle position information is observed by the own-vehicle position observation devices. In FIG. 9 is shown the case in which the time point t_{ego} after amendment is a time point which is the center between t_{obs} (n−1) and t_{obs} (n). Thus, by using two items of own-vehicle movement information u(1) and u(2) at the respective time points t_{ego} (1) and t_{ego} (2) closest to the desired time point t_{ego}, own-vehicle movement information at the time point t_{ego} is calculated by linear approximation such as the undermentioned equation.

$$\begin{matrix}[ Mathematical 1 ] & \\ u ( n ) = u ( 1 ) + \frac{u ( 2 ) - u ( 1 )}{{t}_{ego} ( 2 ) - {t}_{e g o} ( 1 )} ( {t}_{ego} - t ( 1 ) ) & ( 1 )\end{matrix}$$

<Step S2-3-2: Own-Vehicle Position Prediction Value Calculation Step>

In this step, the processing of calculating the own-vehicle position prediction value using the own-vehicle movement information is carried out. Here, the own-vehicle position x_{pred}(n) at the prediction time point t_{obs}(n−1) is calculated using the estimation value xₑₛₜ (n−1) in the previous updating processing, the own-vehicle movement information u(n), and the elapsed time period Δt from the time point t_{obs}((n−1) to the time point t_{obs}(n)). The calculus equation is the undermentioned equation. A and B are the coefficients showing the characteristics of a change in state x from one step before to the next step, and Ppred(n) designates a prediction error covariance matrix, and Q a system error.

[Mathematical 2]

X_{pred}(n)=AXₑₛₜ(n−1)+Bu(n) (2)

[Mathematical 3]

P_{pred}(n)=FPₑₛₜ(n−1)F^{T}+Q (3)

Here, a specific example will be given of the case of predicting and estimating (x, y, θ, v) as the own-vehicle position information. Upon calculating the prediction value, when it is assumed that during the time period Δt from t_{obs}(n−1) to t_{obs}(n), the own vehicle executes a uniform circular motion on orthogonal planes xyθ at a speed v and a yaw rate (angular velocity ω) which are the own-vehicle movement information u(n), the variables in the above-mentioned equation are set as below, and thereby the prediction value x_{pred}(n) can be calculated.

$$\begin{matrix}[ Mathematical 4 ] & \\ {x}_{pred} ( n ) = [ \begin{matrix}\begin{matrix}\begin{matrix}{x}_{pred} \\ {y}_{pred}\end{matrix} \\ {θ}_{pred}\end{matrix} \\ {v}_{pred}\end{matrix} ] , {x}_{est} ( n - 1 ) = [ \begin{matrix}\begin{matrix}\begin{matrix}{x}_{est} \\ {y}_{est}\end{matrix} \\ {θ}_{est}\end{matrix} \\ {v}_{est}\end{matrix} ] , u ( n ) = [ \begin{matrix}v \\ ω\end{matrix} ] & ( 4 )\end{matrix}$$

$$\begin{matrix}[ Mathematical 5 ] & \\ A = [ \begin{matrix}1 & 0 & 0 & 0 \\ 0 & 1 & 0 & 0 \\ 0 & 0 & 1 & 0 \\ 0 & 0 & 0 & 0\end{matrix} ] & ( 5 )\end{matrix}$$

$$\begin{matrix}[ Mathematical 6 ] & \\ B = [ \begin{matrix}Δ t * cos ( {θ}_{est} ) & 0 \\ Δ t * sin ( {θ}_{est} ) & 0 \\ 0 & Δ t \\ 1 & 0\end{matrix} ] & ( 6 )\end{matrix}$$

$$\begin{matrix}[ Mathematical 7 ] & \\ F = [ \begin{matrix}1 & 0 & 0 & 0 \\ 0 & 1 & 0 & 0 \\ - Δ t * v * sin ( {θ}_{pred} ) & Δ t * v * cos ( {θ}_{pred} ) & 1 & 0 \\ Δ t * v * cos ( {θ}_{pred} ) & Δ t * v * sin ( {θ}_{pred} ) & 0 & 1\end{matrix} ] & ( 7 )\end{matrix}$$

$$\begin{matrix}[ Mathematical 8 ] & \\ Q = [ \begin{matrix}{q}_{x}^{2} & 0 & 0 & 0 \\ 0 & {q}_{y}^{2} & 0 & 0 \\ 0 & 0 & {q}_{θ}^{2} & 0 \\ 0 & 0 & 0 & {q}_{v}^{2}\end{matrix} ] & ( 8 )\end{matrix}$$

<Step S2-4: Own-Vehicle Position Estimation Value Updating Processing Step>

In this step, the processing of updating the own-vehicle position estimation value is carried out. Here, the own-vehicle position estimation value updating processing is carried out with the following as input/output information.
Input/Output: t_{obs}(n): Observation time point at which own-vehicle position information z(n) is observed by own-vehicle position observation devices
Input: z(n): Own-vehicle position information observed by own-vehicle position observation devices
Input: sns_id: Identifier representing type of own-vehicle position observation devices
Input reli: Own-vehicle position reliability information outputted by own-vehicle position observation devices
Input: x_{pred}: Own-vehicle position prediction value at time point t_{obs}(n) calculated in prediction processing
Output: xₑₛₜ: Own-vehicle position prediction value at time point t_{obs}(n) calculated in updating processing

<Step S2-4-1: Observation Error Setting Step>

In this step, the value of an observation error parameter R for use in the calculation in the updating processing is changed.

The value of the observation error parameter R is changed with the observation device identifier sns_id and the reliability reli outputted from the observation device as explanatory variables. For this purpose, a table in which the values of sns_id and reli are correlated with the value of the observation error R is prepared in advance.

[Mathematical 9]

R=f(sns_{id},reli) (9)

<Step S2-4-2: Own-Vehicle Position Estimation Value Calculation Step>

In this step, the own-vehicle position estimation value is calculated using the own-vehicle position prediction value obtained in Step S2-3-2, the observation error obtained in Step S2-4-1, and the own-vehicle position information z(n). The calculus equations are shown below. K(n) designates a Kalman gain, and Rest(n) an error covariance matrix after updating.

[Mathematical 10]

K(n)=P_{pred}(n)H^{T}(HP_{pred}((n)H^{T}+R)⁻¹ (10)

[Mathematical 11]

xₑₛₜ(n)=x_{pred}+KY (11)

[Mathematical 12]

Pₑₛₜ(n)=(I−K(n)H)P_{pred}(n) (12)

At this time, the observation information z(n) observes (x, y, θ, v) in the following way, and the set values of the variables in the above equations in the same case as in the one example shown in Step S2-3-2 are as follows.

$$\begin{matrix}[ Mathematical 13 ] & \\ z ( n ) = [ \begin{matrix}\begin{matrix}\begin{matrix}{x}_{obs} \\ {y}_{obs}\end{matrix} \\ {θ}_{obs}\end{matrix} \\ {v}_{obs}\end{matrix} ] & ( 13 )\end{matrix}$$

$$\begin{matrix}[ Mathematical 14 ] & \\ H = [ \begin{matrix}1 & 0 & 0 & 0 \\ 0 & 1 & 0 & 0 \\ 0 & 0 & 1 & 0 \\ 0 & 0 & 0 & 1\end{matrix} ] & ( 14 )\end{matrix}$$

$$\begin{matrix}[ Mathematical 15 ] & \\ y = z ( n ) - {Cx}_{pred} = [ \begin{matrix}\begin{matrix}\begin{matrix}{x}_{obs} \\ {y}_{obs}\end{matrix} \\ {θ}_{obs}\end{matrix} \\ {v}_{obs}\end{matrix} ] - [ \begin{matrix}1 & 0 & 0 & 0 \\ 0 & 1 & 0 & 0 \\ 0 & 0 & 1 & 0 \\ 1 & 0 & 0 & 1\end{matrix} ] [ \begin{matrix}\begin{matrix}\begin{matrix}{x}_{pred} \\ {y}_{pred}\end{matrix} \\ {θ}_{pred}\end{matrix} \\ {v}_{pred}\end{matrix} ] & ( 15 )\end{matrix}$$

$$\begin{matrix}[ Mathematical 16 ] & \\ I = [ \begin{matrix}1 & 0 & 0 & 0 \\ 0 & 1 & 0 & 0 \\ 0 & 0 & 1 & 0 \\ 0 & 0 & 0 & 1\end{matrix} ] & ( 16 )\end{matrix}$$

$$\begin{matrix}[ Mathematical 17 ] & \\ R = [ \begin{matrix}{r}_{x}^{2} & 0 & 0 & 0 \\ 0 & {r}_{y}^{2} & 0 & 0 \\ 0 & 0 & {r}_{θ}^{2} & 0 \\ 0 & 0 & 0 & {r}_{v}^{2}\end{matrix} ] & ( 17 )\end{matrix}$$

This is the end of the per-observation-value loop processing in Step S2-2.

<Step S2-5: Own-Vehicle Position Output Value Output Processing Step>

In this step, own-vehicle position output value output processing is carried out. Here, the output processing is carried out with the following as the input/output information.
Input t_{ego}(m): Observation time points, close to own-vehicle position observation time point t(n), at which M items of own-vehicle movement information are observed
Input u(m): M items of own-vehicle movement information corresponding to t_{ego} (m)
Input t_{obs}(n): Own-vehicle position information observation time point in updating processing
Input: xₑₛₜ(n): Own-vehicle position estimation value in updating processing
Input/output: tₒᵤₜ: Own-vehicle position output time point calculated in own-vehicle position integration processing apparatus
Output: xₒᵤₜ: Own-vehicle position at time point t_{obs}(n) calculated in own-vehicle position integration processing apparatus

<Step S2-5-1: Own-Vehicle Movement Information Amendment Processing Step>

In this step, amendment of the own-vehicle movement information u is carried out. Here, the same processing as in Step S2-3-1 is carried out. The time points used here are from the observation time point t_{obs}(n) to the target predetermined output time point tₒᵤₜ. Specifically, the processing is as follows.

The own-vehicle movement information u(m) which is the input information is amended to the own-vehicle movement information u(n) at the time point t_{ego}. The amended u(n) is used when calculating the own-vehicle position prediction value xₒᵤₜ at the output time point tₒᵤₜ.

As shown in FIG. 9, as for the own-vehicle movement information, the own-vehicle position information at the time point t_{ego} (for example, t_{obs}(n) or the time point at the midpoint between to, and t_{obs} (n)) of the amended own-vehicle information cannot be acquired, either. In FIG. 9, t_{ego} designates the time point of the amended own-vehicle movement information, t_{ego}(1) the own-vehicle movement information observation time point closest to t_{ego}, t_{ego}(2) the own-vehicle movement information observation time point second closest to t_{ego}, t_{obs}(n−1) the own-vehicle position information observation time point in the previous updating processing, and t_{obs}((n) the observation time point at which the own-vehicle position information is observed by the own-vehicle position observation devices. In FIG. 9 is shown the case in which the time point t_{ego} after amendment is a time point which is the center between t_{obs} (n−1) and t_{obs}(n).

Thus, by using two items of own-vehicle movement information u(1) and u(2) at the respective time points t_{ego} (1) and t_{ego} (2) closest to the desired time point t_{ego}, own-vehicle movement information at the time point t_{ego} is calculated by linear approximation such as the undermentioned equation.

$$\begin{matrix}[ Mathematical 18 ] & \\ u ( n ) = u ( 1 ) + \frac{u ( 2 ) - u ( 1 )}{{t}_{ego} ( 2 ) - {t}_{e g o} ( 1 )} ( {t}_{ego} - t ( 1 ) ) & ( 18 )\end{matrix}$$

<Step S2-5-2: Own-Vehicle Position Output Value Calculation Step>

In this step, the calculation of the own-vehicle position output value using the own-vehicle movement information is carried out. Here, the same processing as in Step S2-3-2 is carried out. Specifically, the processing is as follows.

The own-vehicle position xₒᵤₜ (n) at the output time point tₒᵤₜ(n) is calculated using the estimation value xₑₛₜ (n) in the updating processing, the own-vehicle movement information u(n), and the elapsed time period Δt from the time point tₒᵤₜ (n) to the time point tₒᵤₜ. The calculus equation is the following equation.

[Mathematical 19]

xₒᵤₜ(n)=Axₑₛₜ(n)+Bu(n) (19)

Here, in the case of the example shown in Step S2-3-2, the set values of the above equation are as follows.

$$\begin{matrix}[ Mathematical 20 ] & \\ {x}_{out} ( n ) = [ \begin{matrix}\begin{matrix}\begin{matrix}{x}_{out} \\ {y}_{out}\end{matrix} \\ {θ}_{out}\end{matrix} \\ {v}_{out}\end{matrix} ] , {x}_{est} ( n ) = [ \begin{matrix}\begin{matrix}\begin{matrix}{x}_{est} \\ {y}_{est}\end{matrix} \\ {θ}_{est}\end{matrix} \\ {v}_{est}\end{matrix} ] , u ( n ) = [ \begin{matrix}v \\ ω\end{matrix} ] & ( 20 )\end{matrix}$$

$$\begin{matrix}[ Mathematical 21 ] & \\ A = [ \begin{matrix}1 & 0 & 0 & 0 \\ 0 & 1 & 0 & 0 \\ 0 & 0 & 1 & 0 \\ 0 & 0 & 0 & 0\end{matrix} ] & ( 21 )\end{matrix}$$

$$\begin{matrix}[ Mathematical 22 ] & \\ B = [ \begin{matrix}Δ t * cos ( {θ}_{est} ) & 0 \\ Δ t * sin ( {θ}_{est} ) & 0 \\ 0 & Δ t \\ 1 & 0\end{matrix} ] & ( 22 )\end{matrix}$$

This is the end of the own-vehicle position integration processing.

As the own-vehicle position observation devices applied in the embodiment of the present application, a device with a satellite positioning method using the GNSS (Global Navigation Satellite System) mentioned in Background Art, a device with an inertial navigation method using an internal sensor including a gyro, or an observation device which observes the feature information around the own vehicle using an external sensor (for example, a perimeter monitoring camera, a Lidar (Light detection and ranging), or a millimeter-wave radar) can be utilized. Also, as the own-vehicle movement information observation device, for example, a speedometer or an acceleration sensor can be utilized.

In this way, in the own-vehicle position integration processing apparatus according to the first embodiment, there is a prominent advantageous effect in that when estimating the own-vehicle position by integrating the items of own-vehicle position information observed by a plurality of methods, the items of own-vehicle position information are integratively processed with the respective operation and output time points taken into consideration, thereby enabling precise estimation of the own-vehicle position.

The own-vehicle position integration processing apparatus according to the above-mentioned embodiment may be realized as a partial function of a vehicle driving assistance apparatus or may also be realized as an independent apparatus.

### REFERENCE SIGNS LIST

1 own-vehicle position integration processing apparatus, 2 time point management section, 3 own-vehicle movement information management section, 4 observation information management section, 5 prediction section, 6 updating section, 7 output section, 10 own-vehicle position integration processing system, 11 own-vehicle movement information observation device, 12, 13, 14 own-vehicle position observation device, 20 vehicle control device, 80 processing device, 81 storage device, 82 input device, 83 output device, 84 display device

1. An own-vehicle position integration processing apparatus, characterized by comprising:
a prediction circuitry which, by using own-vehicle movement information and an observation time point, which are acquired from an own-vehicle movement information observation device, a present observation time point and a previous observation time point of own-vehicle position information acquired from own-vehicle position observation devices, and an estimation value of a previous own-vehicle position at the previous observation time point, calculates a prediction value of a present own-vehicle position at the present observation time point;
an updating circuitry which calculates and updates an estimation value of the own-vehicle position at the present observation time point by using the prediction value acquired from the prediction circuitry, the present observation time point, and the present own-vehicle position; and
an output circuitry which calculates and outputs an output value in conformity with a predetermined output time point by using the estimation value, the own-vehicle movement information, and the observation time points.

2. The own-vehicle position integration processing apparatus according to claim 1, characterized in that
the calculation of the prediction value and the calculation of the estimation value are sequentially carried out in chronological order of the own-vehicle position information observation time points.

3. The own-vehicle position integration processing apparatus according to claim 1, characterized in that
in calculating the output value, the estimation value at the own-vehicle position information observation time point closest to the output value is used.

4. The own-vehicle position integration processing apparatus according to claim 1, characterized in that
in calculating the prediction value, one or more items of the own-vehicle movement information are used and amended to the own-vehicle movement information at the previous observation time point, at the present observation time point, or at a time point midway between the previous observation time point and the present observation time point.

5. The own-vehicle position integration processing apparatus according to claim 1, characterized in that
in calculating the estimation value, an observation error parameter is changed in accordance with the observation time points at which the own-vehicle movement information and the own-vehicle position information are acquired.

6. The own-vehicle position integration processing apparatus according to claim 1, characterized in that
in calculating the estimation value, an observation error parameter is changed in accordance with the degree of reliability of the own-vehicle position information.

7. The own-vehicle position integration processing apparatus according to claim 1, characterized in that
the observation time points are calculated by taking into consideration a time period required from the observation time point at which the own-vehicle position is observed by the own-vehicle position observation devices until when the own-vehicle position observation information is acquired.

8. An own-vehicle position integration processing method, characterized by comprising:
a step which, by using own-vehicle movement information and an observation time point, which are acquired from an own-vehicle movement information observation device, a present and a previous observation time point of own-vehicle position information acquired from own-vehicle position observation devices, and an estimation value of a previous own-vehicle position at the previous observation time point, calculates a prediction value of a present own-vehicle position at the present observation time point;
a step which calculates and updates an estimation value of the own-vehicle position at the present observation time point by using the prediction value, the present observation time point, and the present own-vehicle position; and
a step which calculates and outputs an output value in conformity with a predetermined output time point by using the estimation value, the own-vehicle movement information, and the observation time points.

9. The own-vehicle position integration processing method according to claim 8, characterized in that
the calculation of the prediction value and the calculation of the estimation value are sequentially carried out in chronological order of the own-vehicle position information observation time points.

10. The own-vehicle position integration processing method according to claim 8, characterized in that
in calculating the output value, the estimation value at the own-vehicle position information observation time point closest to the output value is used.

11. The own-vehicle position integration processing method according to claim 8, characterized in that
in calculating the prediction value, one or more items of the own-vehicle movement information are used and amended to the own-vehicle movement information at the previous observation time point, at the present observation time point, or at a time point midway between the previous observation time point and the present observation time point.

12. The own-vehicle position integration processing method according to claim 8, characterized in that
in calculating the estimation value, an observation error parameter is changed in accordance with the observation time points at which the own-vehicle movement information and the own-vehicle position information are acquired.

13. The own-vehicle position integration processing method according to claim 8, characterized in that
in calculating the estimation value, an observation error parameter is changed in accordance with the degree of reliability of the own-vehicle position information.

14. The own-vehicle position integration processing method according to claim 8, characterized in that
the observation time points are calculated by taking into consideration a time period required from the observation time point at which the own-vehicle position is observed by the own-vehicle position observation devices until when the own-vehicle position observation information is acquired.
